(19) United States
(12) Patent Application Publication
(10) Pub. No.: US 2008/0046925 A1
(43) Pub. Date: Feb. 21, 2008

(54) TEMPORAL AND SPATIAL IN-VIDEO MARKING, INDEXING, AND SEARCHING

(75) Inventors: PHILIP LEE, BELLEVUE, WA (US); NIRANJAN VASU, BELLEVUE, WA (US); YING LI, BELLEVUE, WA (US); TAREK NAJM, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/465,348

(22) Filed: Aug. 17, 2006

(51) Int. Cl. H04N 7/16; G06F 13/00; G06F 3/048; H04N 5/445; G06F 3/00

(52) U.S. Cl. 725/37; 725/135; 725/136; 725/52; 715/825; 715/841

(57) ABSTRACT

Synchronized marking of videos with objects is provided. Users may select frames within a video and place text and non-text objects at desired spatial locations within each of the frames. Information associated with the objects, including information specifying the temporal and spatial placements of the objects within the video is stored. When users view a marked video, object information is accessed, and objects are presented in the video at the temporal and spatial locations at which the objects were added. Objects added to videos may also be indexed, providing a mechanism for searching videos and jumping to particular frames within videos. Objects may also be monetized.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The popularity of digital videos has continued to grow exponentially as technology developments have made it easier to capture and share videos. A variety of video-sharing websites are currently available, including Google Video™ and YouTube™, that provide a more convenient approach for sharing videos among multiple users. Such video-sharing websites allow users to upload, view, and share videos with other users via the Internet. Some video-sharing websites also allow users to add commentary to videos. Traditionally, the user commentary that may be added to videos has been static—a couple of sentences to describe the entire video. In other words, the user commentary treats the video as a whole. However, videos are not static and contain a temporal aspect with the content changing over time. Static comments fail to account for the temporal aspect of videos, and as a result, are a poor way for users to interact with a video.

Some users may have advanced video editing software that allows the users to edit their videos, for example, by adding titles and other effects throughout the video. However, the use of advanced video editing software in conjunction with video-sharing websites does not provide a convenient way for multiple users to provide their own commentary or other effects to a common video. In particular, users would have to download a video from a video-sharing website and employ their video editing software to make edits. The users would then have to upload the newly edited video to the video-sharing website. The newly edited video would be added to the website as a new video, in addition to the original video. Accordingly, if this approach were used, a video-sharing website would have multiple versions of the same underlying video with different edits made by a variety of different users. Further, when users edit videos using such video editing software, the users are modifying the content of the video. Because the video content has been modified by the edits, other users may not simply watch the video without the edits or with only a subset of the edits made by other users.

Another drawback of current video-sharing websites is that current discovery mechanisms for videos on video-sharing websites have also made it difficult to sort through and browse the vast number of videos. Some video-sharing websites allow users to tag videos with keywords, and provide search interfaces for locating videos based on the keywords. However, similar to static commentary, current tags treat videos as a whole and fail to account for the temporal aspect of videos. Users may not wish to watch an entire video, but instead may want to jump directly to a particular point of interest within a video. Current searching methods fail to provide this ability.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to allowing users to share videos and mark shared videos with objects, such as commentary, images, audio clips, and video clips, in a manner that takes into account the spatial and temporal aspects of videos. Users may select frames within a video and locate objects within the selected frames. Information associated with each object is stored in association with the video. The information stored for each object may include, for example, the object or an object identifier, temporal information indicating the frame marked with the object, and spatial information indicating the spatial location of the object within the frame. When other users view the video, the object information may be accessed such that objects are presented at the time and spatial location within the video at which they were placed. Objects may also be indexed, providing a mechanism for searching videos based on objects, as well as jumping to particular frames marked with objects.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a block diagram of an exemplary system for sharing, marking, indexing, and searching videos in accordance with an embodiment of the present invention;

FIG. 3 is a flow diagram showing an exemplary method for marking a video frame with an object in accordance with an embodiment of the present invention;

FIG. 4 is a flow diagram showing an exemplary method for viewing a video marked with objects in accordance with an embodiment of the present invention;

FIG. 5 is a flow diagram showing an exemplary method for indexing objects marking a video in accordance with an embodiment of the present invention;

FIG. 6 is a flow diagram showing an exemplary method for search videos using indexed objects in accordance with an embodiment of the present invention;

FIG. 7 is an illustrative screen display of an exemplary user interface allowing a user to mark a video with objects after uploading the video to a video-sharing server in accordance with an embodiment of the present invention;

FIG. 8 is an illustrative screen display of an exemplary user interface for viewing a video marked with objects in accordance with an embodiment of the present invention;

FIG. 9 is an illustrative screen display of an exemplary user interface showing a user marking a video the user is watching with objects in accordance with an embodiment of the present invention; and

FIG. 10 is an illustrative screen display of an exemplary user interface for viewing a video, marking the video with objects, and searching for videos in accordance with another embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide an approach to sharing and marking videos with objects, such as text, images, audio, video, and various forms of multi-media content. A synchronized marking system allows users to mark videos by inserting objects, such as user commentary and multimedia objects, into one or more frames of the video. For example, on any frame of a video, a user may mark any part of the frame with an object. The object is then visible to all other users, being displayed at the location and time within the video that the user placed the object. Marking may be done in a wiki-like fashion, in which multiple users may add objects at various frames throughout a particular video, as well as view the video with objects added by other users. Such marking serves multiple purposes, including, among others, illustration, adding more information, enhancing or modifying the video for viewers, personal expression, discovery of videos and frames within videos, and serving advertisements within and associated with the video. In some embodiments, an object used to mark a video may be indexed, thereby facilitating user searching. When searched, a preview of the frame on which the object has been placed may be presented to the user. The user may select the frame allowing the user to jump to that frame within the video.

Embodiments of the present invention, provide, among other things, functionality not available to traditional static video commenting on video-sharing websites due to the temporal aspect of videos (i.e., videos are not static). One benefit is improved interactions between users. Instead of a static comment to describe the whole video, embodiments provide synchronized commentary that allow users to indicate exactly where and when in a video a commentary is referring. For example, if a user wishes to comment on a car that appears in only a portion of a video, the user may place the comment at the frame the car appears in the video, thereby indicating the car itself within the frame of the video. Additionally, objects added by users do not modify the content of the video, but instead are saved in conjunction with a video, allowing users to filter objects when viewing videos. Further, synchronized objects provide a way to search videos not traditionally possible. For example, users can mark video frames having cars with corresponding comments and other types of objects. Then, when users search for “cars,” video frames with cars are easily located and provided to users. Further, synchronized objects make it possible to provide advertising, including contextually-relevant ads, on any frame within a video. For example, on a frame where users have added commentary that include “cars,” advertising associated with cars may be displayed. In some cases, an inserted object may itself be an advertisement (e.g., a logo). Additionally, objects may be automatically or manually linked to other content, including advertisements. For example, a user may mark a frame with an object that is hyperlinked, such that clicking or doing a mouse-over on the object results in the user seeing a hyperlinked advertisement (e.g., in the same window or a new window opened by the hyperlink). In addition to advertising, other approaches to monetizing objects for marking videos may be provided in accordance with various embodiments of the present invention. For example, objects may be purchased by end users for insertion in a video.

Accordingly, in one aspect, an embodiment of the invention is directed to a method for marking a video with an object without modifying the content of the video. The method includes receiving a user selection of a frame within the video. The method also includes receiving user input indicative of spatial placement of the object within the frame. The method further includes receiving user input indicative of temporal placement of the object within the frame. The method still further includes storing object information in a data store, wherein the object information is stored in association with the video and includes the object or an identifier of the object, temporal information indicative of the frame within the video, and spatial information indicative of the spatial location of the object within the frame based on the placement of the object within the frame.

In another aspect of the invention, an embodiment is directed to a method for indexing an object marking a frame within a video. The method includes determining a tag associated with the object. The method also includes accessing a data store for indexing objects used to mark one or more videos. The method further includes storing, in the data store, information indicative of the tag associated with the object, the video, and the frame within the video marked with the object.

In a further aspect, an embodiment of the present invention is directed to a method for searching videos using an index storing information associated with objects marking the videos. The method includes receiving search input and searching the index based on the search input. The method also includes determining frames within the videos based on the search input, the frames containing objects corresponding with the search input. The method further includes presenting the frames.

### Exemplary Operating Environment

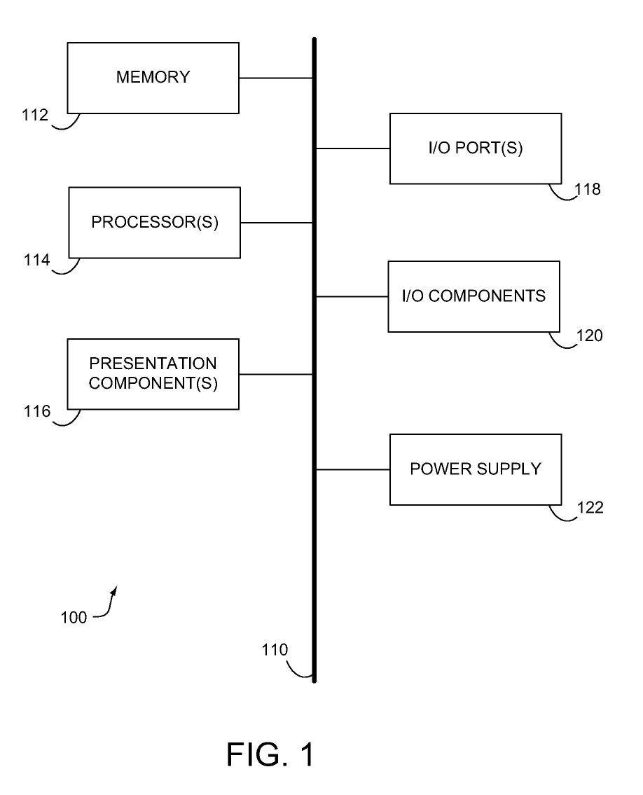

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Exemplary System

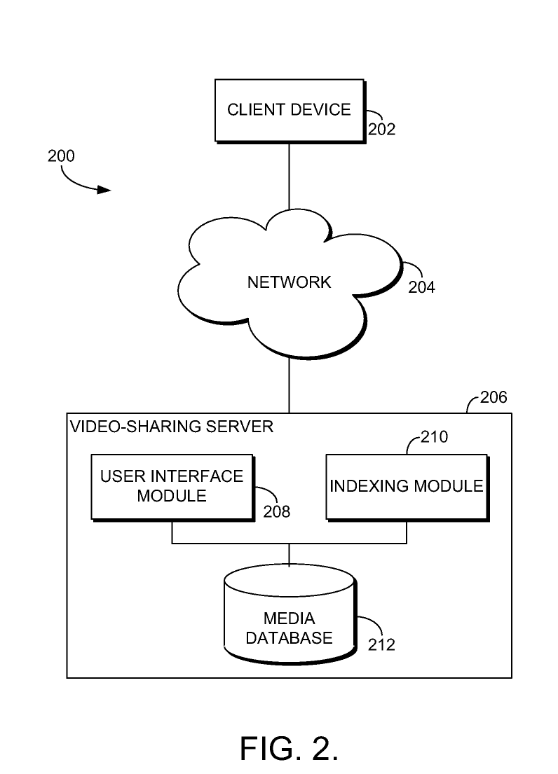

Referring now to FIG. 2, a block diagram is shown of an exemplary system 200 in which exemplary embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

As shown in FIG. 2, the system 200 may include, among other components not shown, a client device 202 and a video-sharing server 206. By employing the system 200, users may upload, view, and share videos using the video-sharing server 206. Additionally, users may mark videos with objects and search videos by employing object marking in accordance with embodiments of the present invention.

The client device 202 may be any type of computing device, such as, for example, computing device 100 described above with reference to FIG. 1. By way of example only and not limitation, the client device 202 may be or include a desktop, laptop computer, or portable device, such as a network-enabled mobile phone, for example. The client device 202 may include a communication interface that allows the client device 202 to be connected to other devices, including the video-sharing server 206, either directly or via network 204. The network 204 may include one or more wide area networks (WANs) and/or one or more local area networks (LANs), as well as one or more public networks, such as the Internet, and/or one or more private networks. In various embodiments, the client device 202 may be connected to other devices and/or network 204 via a wired and/or wireless interface. Although only a single client device 202 is shown in FIG. 2, in embodiments, the system 200 may include any number of client devices capable of communicating with the video-sharing server 206.

The video-sharing server 206 generally facilitates sharing videos between users, such as the user of the client device 202 and users of other client devices (not shown), and marking videos with objects in a wiki-like fashion. The video-sharing server also provides other functionality in accordance with embodiments of the present invention as described herein, such as indexing objects and using the indexed objects for searching. The video-sharing server 206 may be any type of computing device, such as the computing device 100 described above with reference to FIG. 1. In some embodiments, the video-sharing server may be or include a server, including, for instance, a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In addition to components not shown, the video-sharing server 206 may include a user interface module 208, an indexing module 210, and a media database 212. In various embodiments of the invention, any one of the components shown within the video-sharing server 206 may be integrated into one or more of the other components within the video-sharing server 206. In other embodiments, one or more of the components within the video-sharing server 206 may be external to the video-sharing sever 206. Further, although only a single video-sharing server 206 is shown within system 200, in embodiments, multiple video-sharing servers may be provided.

In operation, a user may upload a video from the client device 202 to the video-sharing server 208 via the network 204. The video-sharing server 208 may store the video in a media database 212. After a video is uploaded, users having access to the video-sharing server 208, including the user of the client device 202 and users of other client devices (not shown), may view the video and mark the video with objects.

The video-sharing server includes a user interface module 208 that facilitates video viewing and object marking in accordance with embodiments of the present invention. The user interface module 208 may configure video content for presentation on a client device, such as the client device 202. Additionally, the user interface module 208 may be used to provide tools to users for marking a video with comments. Further, the user interface module 208 may provide users with a search interface allowing users to enter search input to search for videos stored in the media database 212 based on indexed objects.

An indexing module 210 is also provided within the video-sharing server 206. When users mark videos with objects, the indexing module 210 may store information associated with the objects in the media database 212. For a particular object, such information may include the object or an object identifier, temporal information indicative of the frame that was marked, spatial information indicative of the spatial location within a frame an object was placed, and other relevant information. The indexing module 210 may also index information associated with objects to facilitate searching (as will be described in further detail below).

### Marking Videos with Objects

As previously mentioned, some embodiments of the present invention are directed to a synchronized marking system that allows users to mark videos with objects in a way that takes into account both the spatial and temporal aspects of videos. By way of example only and not limitation, objects that may be used to mark a video include text (e.g., user commentary and captions), audio, still images, animated images, video, and rich multi-media.

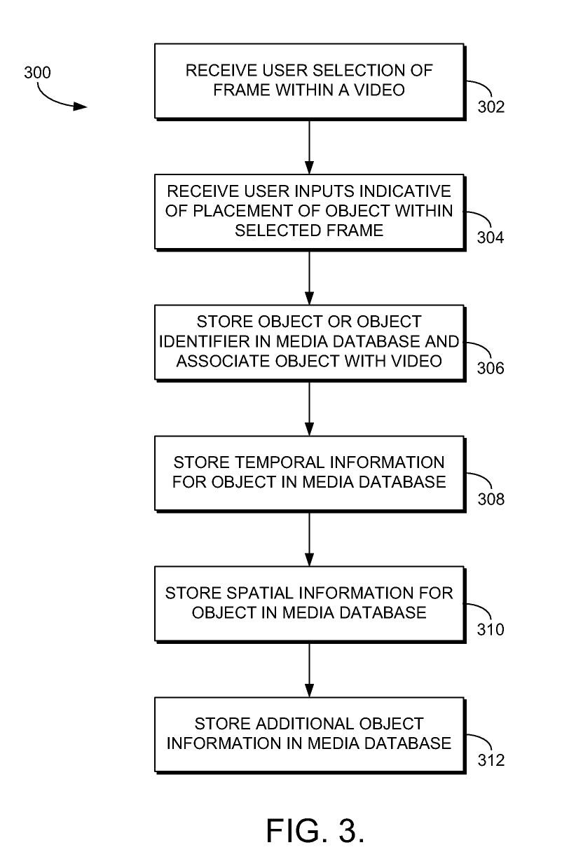

Referring to FIG. 3, a flow diagram is provided showing an exemplary method 300 for marking a video with an object in accordance with an embodiment of the present invention. As shown at block 302, a video-sharing server, such as the video-sharing server 206 of FIG. 2, receives a user selection of a frame within a video that a user wishes to mark with an object. The selection of a frame to be marked with an object may be performed in a number of different ways within the scope of the present invention. For example, in one embodiment, a user may select a frame while watching a video. In particular, a user may access the video-sharing server using a client device, such as the client device 202 of FIG. 2, and request a particular video. Based upon the request, the video is presented to the user, for example, by streaming the video from the video-sharing server to the client device. While the user is watching the video, the user may decide to mark a particular frame with an object and may pause the video to select a frame. Other methods of selecting a frame within a video may also be employed, such as, for example, a user providing a time corresponding with a particular frame, or a user jumping to a frame previously marked with an object (as will be described in further detail below).

After a user selects a frame, the user may mark the frame with an object. Accordingly, as shown at block 304, the video-sharing server receives user inputs indicative of the placement of an object within the selected frame. This may also be performed in a variety of manners within the scope of the present invention. For example, with respect to a text-based object, such as a user commentary, the user may drag a text box on the location of the frame the user wishes to mark. The user may then enter the commentary into the text box. With respect to a non-text object, the user may select the object, drag the object to a desired location within the frame, and drop the object. In some cases, a user may select an object from a gallery of common objects provided by the video-sharing server. In other cases, a user may select an object from another location, such as by selecting an object stored on the hard drive of the user's client device, which uploads the object to the video-sharing server.

As shown at block 306, the video-sharing server stores the object or an object identifier in a media database, such as the media database 212 of FIG. 2, and associates the object with the video that has been marked. Whether the video-sharing server stores the object or an object identifier may depend on a variety of factors, such as the nature of the object. For example, in the case of a text-based object, the video-sharing server may store the object (i.e., the text). Similarly, in the case of an object, such as an audio file, selected from the user's client device, the object may be uploaded from the client device and stored by the video-sharing server. In the case of an object commonly used to mark videos, the video-sharing server may simply store an identifier for the object, which may be stored separately.

The video-sharing server also stores temporal information associated with the object in the media database, as shown at block 308. In particular, the video-sharing server stores information corresponding with the frame that was selected previously at block 302. The information may include, for example, the time that the frame occurs within the video. In addition to temporal information, the video-sharing server stores spatial information for the object in the media database, as shown at block 310. The spatial information includes information indicating the spatial location within the frame at which the object was placed.

The spatial information may be captured and stored in variety of ways to indicate an area within the frame of the video. For example, one way to store the spatial information is in the form of four sets of coordinates in either absolute or relative scale, such that each coordinate corresponds to the corner of a rectangle. Another way is to enable a free-form line or shape-drawing tool that stores any number of coordinate points needed to mark a portion of the frame of the video. The temporal information could be stored in a variety of ways as well. For example, one way is based on elapsed time from the beginning of the video.

In some embodiments, the video-sharing server may store a variety of other object information in the media database in addition to temporal and spatial information, as shown at block 312. For example, an identification of the user marking the video with the object may be stored. Additionally, the object may include a hyperlink, and information corresponding with the hyperlink may be stored. In some cases, an object may be associated with an advertisement. For instance, advertisers may sponsor common objects provided by the video-sharing server such that when a sponsored object appears in a video, a corresponding advertisement is also presented. In other cases, contextual based advertising, such as selecting advertising based on keywords presented in text-based objects, may be provided. Accordingly, any advertising information associated with an object may be stored in the media database. Further, in some embodiments, users may select a particular length of time that an object should be shown within a video. In such embodiments, information associated with an indicated length of time may also be stored in the media database. One skilled in the art will recognize that a variety of other information may also be stored in the media database.

### Viewing Videos Marked with Objects

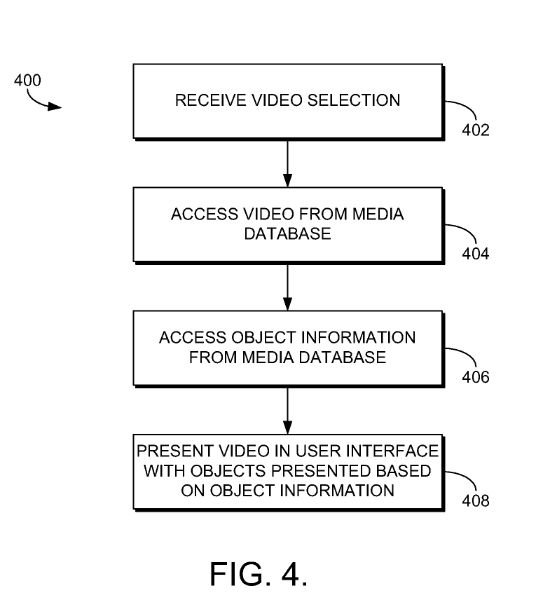

When users view a video that has been marked with one or more objects, the objects are presented in the video where they were placed by users based on information stored in the media database as described above. Turning now to FIG. 4, a flow diagram is provided illustrating an exemplary method 400 for presenting a video marked with one or more objects. Initially, as shown at block 402, a video selection is received by a video-sharing server, such as the video-sharing server 206 of FIG. 2. At block 404, the video-sharing server accesses the selected video from a media database, such as the media database 212 of FIG. 2. Additionally, the video-sharing server accesses object information associated with the video from the media database, as shown at block 406. The video is then presented to the user, for example, by streaming the video from the video-sharing server to a client device, such as the client device 202 of FIG. 2, as shown at block 408. Objects are presented in the video based on object information for the video that was accessed from the media database. In particular, objects are presented at the respective frames marked with the objects. In other words, the objects are presented at the respective times within the video at which users have marked with the objects. Additionally, the objects are located spatially within the video based on the location at which the objects were placed by users who marked the video. In various embodiments of the present invention, objects may remain presented within the video for a default period of time (e.g., five seconds), for a user-specified period of time, or for a system or algorithmically determined period of time. Advertisements may also appear as the video is presented.

In some embodiments, controls may be provided allowing users to filter objects that are presented while a video is presented. A wide variety of filters may be employed with the scope of the present invention. By way of example only and not limitation, the filters may include an object-type filter and a user filter. An object-type filter would allow a user to select the type of objects presented while the user views the video. For instance, the user may select to view only text-based objects, such that other types of objects, such as images or audio clips, are not presented. A user filter would allow a user to control object presentation based on the users who have added the objects. For instance, a user may be able to create a “friends” list that allows the user to designate other users as “friends.” The user may then filter objects by selecting to view only objects added by a selected subset of users, such as one or more of the user's “friends.”

### Editing Objects

Users may also edit objects marking videos after the objects have been inserted into the videos. Objects may be edited in a variety of different ways within the scope of the present invention. By way of example only and not limitation, a user may edit the text of a comment or other text-based object (e.g., correct spelling, edit font, or change a comment). A user may also change the spatial location of an inserted object within a frame (e.g., move an inserted object from one side of a frame to the other side of the frame). As another example, a user may change the frame at which an object appears (e.g., moving an object to a later frame in a video). As a further example, a user may delete an object from a video. When a user edits an object, stored object information for that object is modified based on the edits.

In various embodiments of the present invention, different user permission levels may be provided to control object editing by users. For example, in some cases, a user may edit only those objects the user added to videos. In other cases, users may be able to edit all objects. In further cases, one or more users may be designated as owners of a video, such that only those users may edit objects added to the video by other users. Those skilled in the art will recognize that a variety of other approaches to providing permission levels for editing objects may be employed. Any and all such variations are contemplated to be within the scope of the present invention.

### Indexing Objects

In some embodiments of the present invention, objects may be indexed to facilitate searching videos. An index may be maintained, for example, by a media database, such as the media database 212 of FIG. 2, to store information associated with objects, allowing users to search and find video frames based on objects marking the frames. The index may include information identifying one or more videos, as well as one or more frames within each video, corresponding with object tags. As used herein, the term “tag” refers to a keyword or identifier that may be associated with an object and used for searching.

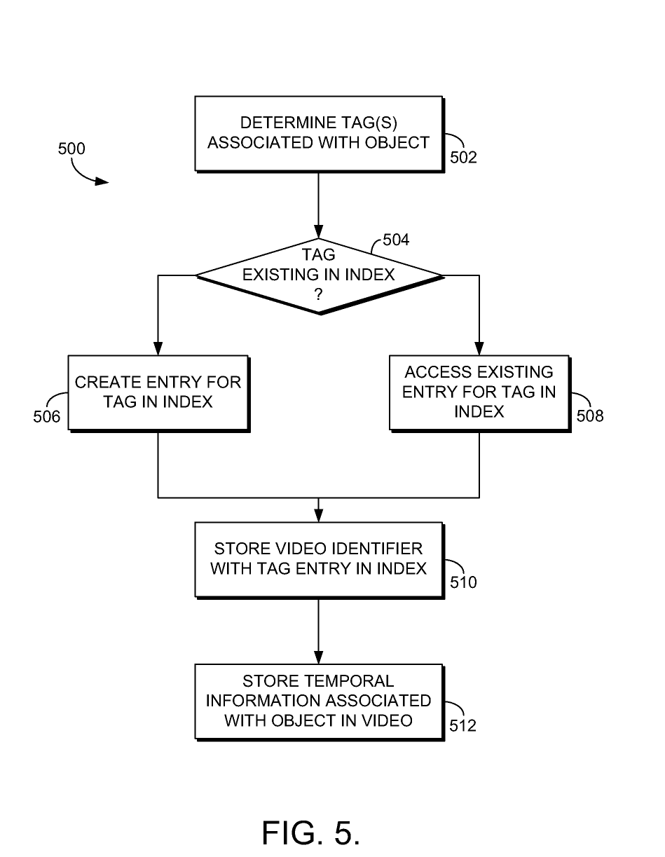

Turning now to FIG. 5, a flow diagram is provided showing an exemplary method 500 for indexing an object marking a video. After a video has been marked with an object, one or more tags associated with the object are determined, as shown at block 502. In various embodiments, tags may be automatically determined by the system or manually assigned by a user. Typically, the determination of a tag for an object may depend on the type of object. For example, for a text-based object, determining tags for the object may include automatically identifying keywords within the text and assigning the keywords as tags for that object. This may include extracting words from the text, which may include phrasal extraction to extract phrases, such as “tropical storm” or “human embryo.” Each phrase may then be treated as a discrete keyword. A variety of preprocessing may also be performed. For example, stemming functionality may be provided for standardizing words from a text-based object. Stemming transforms each of the words to their respective root words. Next, stop-word filtering functionality may be provided for identifying and filtering out stop words, that is, words that are unimportant to the content of the text. In general, stop words are words that are, for example, too commonly utilized to reliably indicate a particular topic. Stop words are typically provided by way of a pre-defined list and are identified by comparison of the stemmed word sequence with the pre-defined list. One skilled in the art will recognize that the foregoing description of preprocessing steps is exemplary and other forms of preprocessing may be employed within the scope of the present invention.

For a non-text object, one or more tags may be assigned automatically by the system and/or manually by a user. For instance, each common object provided by a video-sharing server may be automatically assigned a tag by the system for identifying and indexing each object. Typically, the tag will be an identifier for the object, although keywords may also be automatically associated with such non-text objects. Users may also be able to manually assign tags for non-text objects. For instance, a user could assign one or more keywords with a non-text object.

After determining a tag for an object, the system determines whether an entry for the tag exists in the index, as shown at block 504. If there is not a current entry in the index for the tag, an entry in the index is created, as shown at block 506. Alternatively, if there is a current entry in the index for the tag, the existing entry is accessed, as shown at block 508.

After either creating a new index or accessing a current index for the tag, a video identifier, used to identify the video that has been marked with the object, is stored with the tag entry in the index, as shown at block 510. Additionally, temporal information associated with the object is stored, as shown at block 512. The temporal information includes information indicating the frame at which the object was placed within the video.

### Searching Videos Using Object Indexing

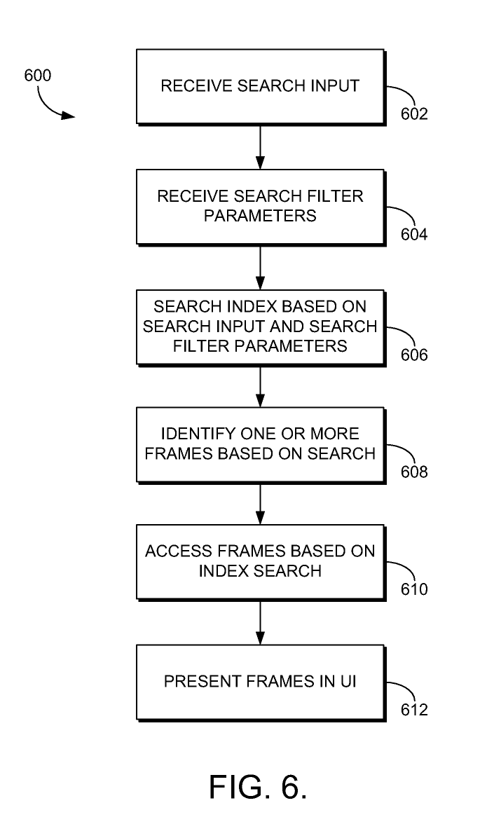

Referring now to FIG. 6, a flow diagram is provided showing an exemplary method 600 for searching videos using object indexing in accordance with an embodiment of the present invention. Initially, as shown at block 602, a search input is received. The search input may include one or more keywords and/or identifiers. For instance, a user could enter a keyword, such as “car.” As another example, a user could enter an identifier for a particular common object.

In some embodiments, such as that shown in FIG. 6, the user may also specify one or more filter parameters for a search. Accordingly, as shown at block 604, search filter parameters are received. A wide variety of filter parameters may be employed within the scope of the present invention, including, for example, filtering by user or video. For instance, a user may wish to search for objects added by particular users, ranging from one particular user to all users. For example, a user may wish to search for objects based on friends and/or friends of friends. Additionally, a user may wish to search for objects within one video, a subset of videos, or all videos stored by the video-sharing server.

As shown at block 606, an index, such as the index discussed above with reference to FIG. 5, is searched based on the search input and any search filter parameters. Based on the search, one or more frames within one or more videos are identified, as shown at block 608. The one or more frames identified by the search are then accessed, as shown at block 610. For example, the index information identifying the frames and videos may be used to access the frames from the videos stored in a media database, such as the media database 212 of FIG. 2. As shown at block 612, the frames are presented to the user as search results within a user interface. In an embodiment, the frames are presented in the user interface as a thumbnails. The user may select a particular frame, causing the video to be accessed and presented at that frame.

### Exemplary Screen Displays

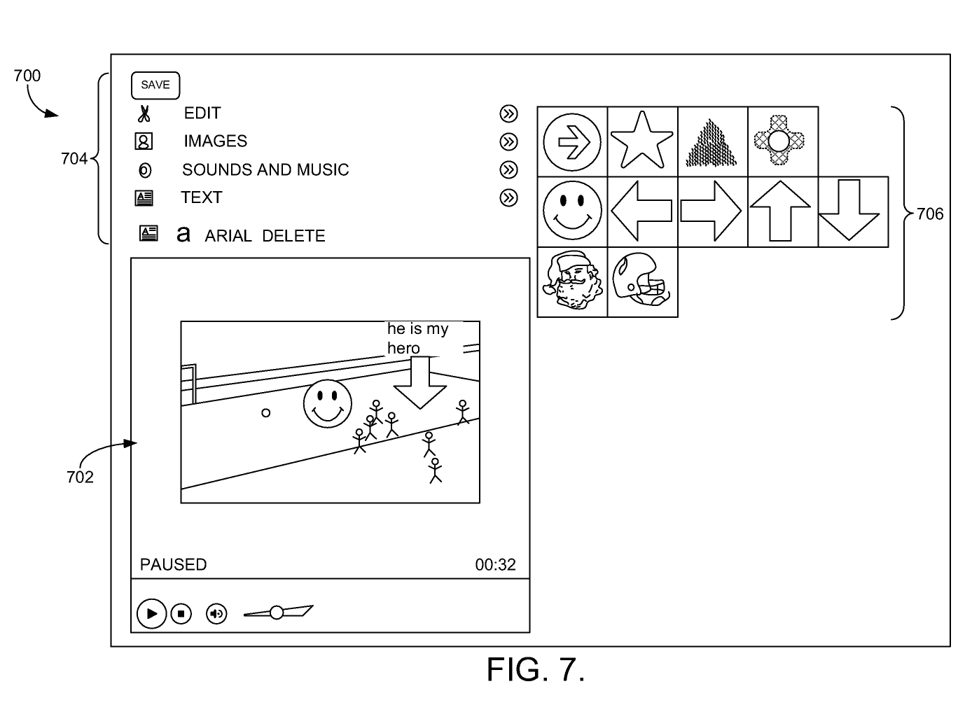

Various embodiments of the present invention will now be further described with reference to the exemplary screen displays shown in FIG. 7 through FIG. 10. It will be understood and appreciated by those of ordinary skill in the art that the screen displays illustrated in FIG. 7 through FIG. 10 are shown by way of example only and are not intended to limit the scope of the invention in any way.

Referring initially to FIG. 7, a screen display is providing showing an exemplary user interface 700 allowing a user to mark a video with objects after uploading the video to a video-sharing server, such as the video-sharing server 206 of FIG. 2, in accordance with an embodiment of the present invention. In the present example, a user has uploaded a video of a soccer match. After uploading the video, the user may view the video in a video player 702 provided in the user interface 700. Additionally, the user interface 700 provides the user with a number of controls 704 for marking the video with objects. Some controls may provide the user with a gallery of common objects available from the video-sharing server for marking videos. For example, as shown in FIG. 7, a gallery 706 of images is currently provided. In various embodiments, galleries of other types of objects, such as audio or video clips, may also be provided. Additionally, as discussed previously, in some embodiments, users may upload objects, such as images, audio, and video, from a client device to the video-sharing server to mark a video with such objects. A variety of additional tools may be provided in the user interface, such as text formatting tools and drawings tools.

To mark the uploaded video with objects, the user may watch the video in the video player 702. When the video reaches a frame the user would like to mark, the user may pause the video at that frame. The user may then add objects to the current frame. As shown in FIG. 7, the user has added an arrow to the current frame to point out a particular soccer player in the video. The user may add the arrow to the frame, for example, by selecting the arrow from the gallery 706 and positioning the arrow at a desired location within the frame. The user has also added the caption “he is my hero.” Additionally, the user has added a happy face to the current frame. Similar to the arrow, the happy face may be added to the frame by selecting the happy face from the gallery 706 and positioning the happy face at a desired location with the selected frame.

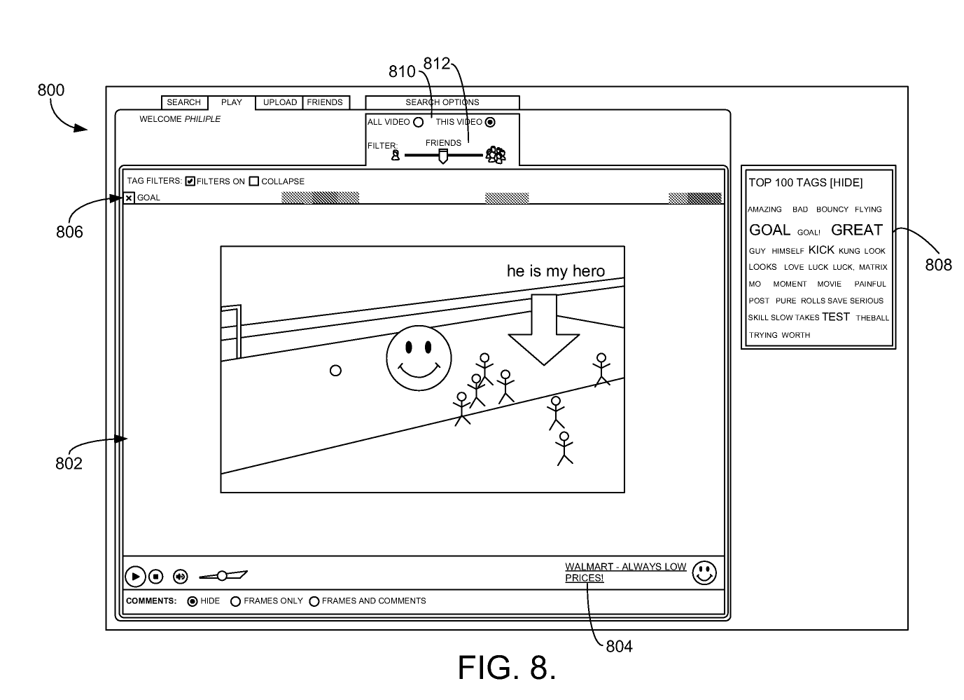

After a user has uploaded a video to a video-sharing server, other users may access, view, and mark the video. Referring to FIG. 8, a screen display is provided showing an exemplary user interface 800 allowing a second user to view a video that has been uploaded to the video-sharing server in accordance with an embodiment of the present invention. As the second user watches the video uploaded and marked by the first user (as described above with reference to FIG. 7), the objects included by the first user are presented within the video. For example, as shown in the video player 802, the arrow, the caption “he is my hero,” and the happy face that were added by the first user are presented when the second user watches the video. The objects are presented at the same location (spatially and temporally) within the video as they were placed by the first user. Additionally, the happy face is linked to an advertisement for Wal-Mart®. Accordingly, an advertisement 804 is presented within the video player when the happy face is presented. The happy face object and/or the advertisement 804 may be hyperlinked to the advertiser's website. For example, when a user clicks on the happy face or the advertisement 804, the user may be navigated to a website for Wal-Mart®, for example, in the same window or in a new window.

The user interface 800 of FIG. 8 also includes a keyword density map 806, which generally provides a timeline of the current video with an indication of the placement of objects associated with a selected keyword throughout the video. The darker the portion of the keyword density map 806, the more objects associated with the selected keyword appear in the corresponding portion of the video. For example, the keyword density map 806 in FIG. 8 provides an indication of comments and other objects having a tag that includes the keyword “goal” within the video. This may be useful to allow a user to find portions of interest within the video. For instance with respect to the current example of a video of a soccer match, by providing an indication of the density of objects associated with the keyword “goal” in the video, a user may quickly determine points in the match when a goal was scored.

As shown in the user interface 800 of FIG. 8 is a tag cloud 808. The tag cloud 808 provides an assortment of keywords associated with objects in one or more videos. Users may manually control filtering for the tag cloud, such as, for example, the videos and users included to generate the tag cloud 808. For example, the slider bars 810 and 812 may be used to set the video and user filters, respectively for the tag cloud. One skilled in the art will recognize that other types of mechanisms for selecting filter settings may be provided within the scope of the invention. Text size of keywords in the tag cloud 808 may be used to identify the user of the keyword (e.g., the larger the text for a keyword, the more frequent that keyword is used). In some embodiments, a user may use the keywords in the tag cloud 808 for searching purposes. In particular, when a user hovers over a keyword or otherwise selects a keyword, one or more frames associated with the keyword may be presented to the user.

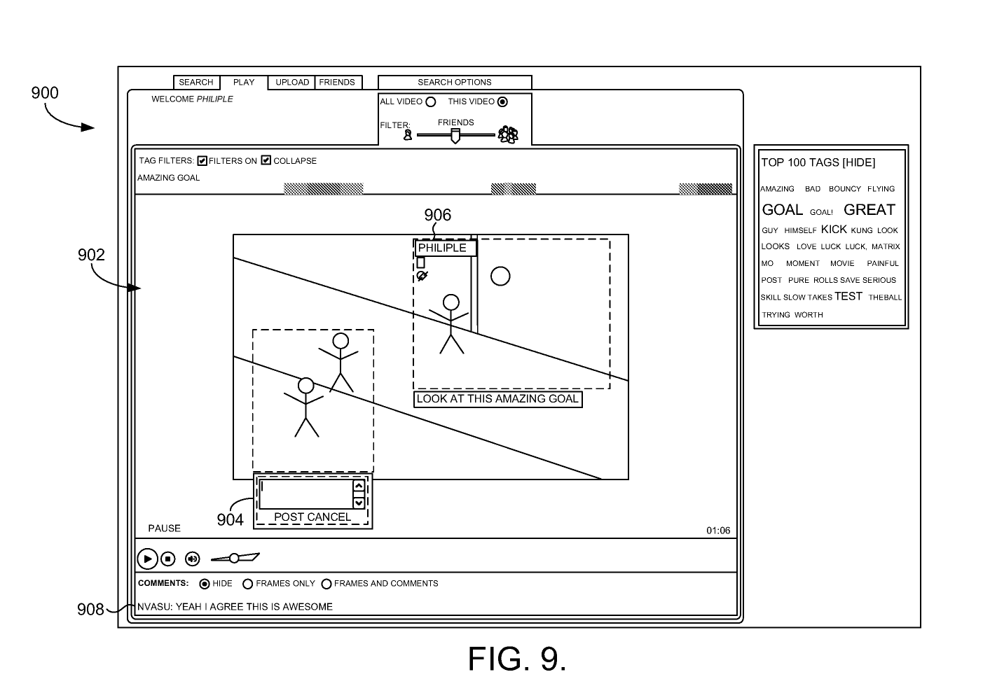

As a user is watching a video, the user may decide to add their own comments or other objects. For example, FIG. 9 shows a screen display that includes a user interface 900 allowing a user to mark a video with an object. As shown in FIG. 9, the user has paused the video in the video player 902 at a frame the user wishes to make a comment. The user selects a location within the frame for the comment, and a text box 904 is provided at that location. The user may then enter the comment, and select to either post or cancel the comment. Additionally, the user may view information associated with objects inserted by other users. For instance, object information 906 is provided for the comment “look at this amazing goal.” The object information may include, for example, an indication of the user who added the comment. Further, the user may view a comment 908 that was added by another user in response to the comment “look at this amazing goal.”

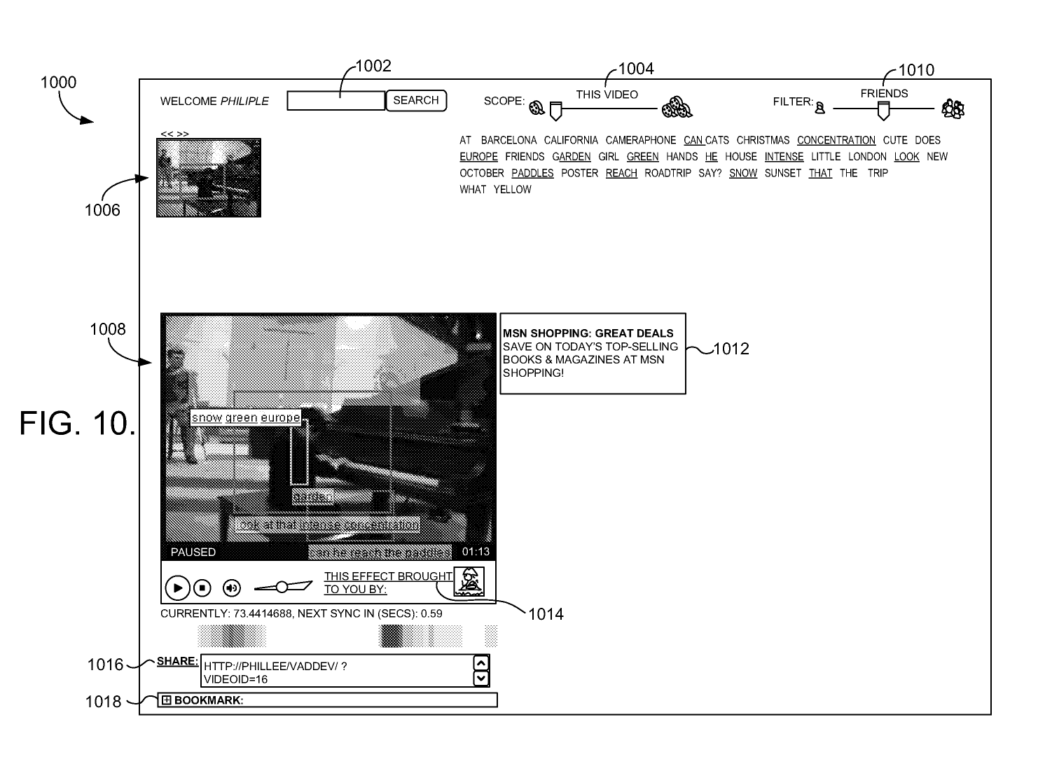

Referring now to FIG. 10, a screen display is illustrated showing an exemplary user interface 1000 in accordance with another embodiment of the present invention. As shown in FIG. 10, the user interface 1000 includes a search input component 1002 that allows a user in to provide a search input. In the present example, the user has entered the keyword “concentration.” Additionally, the user has chosen to search only the current video by using the scope slider bar 1004. A search result area 1006 presents frames relevant to the search query. In particular, a thumbnail for a frame matching the search parameters is shown. When a user selects the frame, the video is presented at that frame in the video player 1008. The video is presented with objects added by various users, as filtered by the friend slider bar 1010. As shown in FIG. 10, a number of user comments have been added to the video. Contextual advertising 1012 is also presented based on keywords provided by the comments in the current frame. Additionally, a sound effect has been added by a user, which is played when the current user views the video. The sound effect is linked to an advertisement 1014, which may be presented simultaneously with the sound effect. The user interface 1000 further includes a share area 1016 that allows users to share frames with other users. For example, a user may select the current frame and specify a friend's email address or instant messaging account. A link is then sent to the friend, who may use to link to access the video, which is presented at the selected frame. Still further, the user interface 1000 includes a bookmark area 1018 that allows users to bookmark particular frames. Users may employ the bookmarks to jump to particular frames within videos.

As can be understood, embodiments of the present invention provide an approach for sharing videos among multiple users and allowing each of the multiple users to mark the videos with objects, such as commentary, images, and media files. Further embodiments of the present invention provide an approach for indexing objects used to mark videos. Still further embodiments of the present invention allow users to search for videos based on indexed objects.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for marking a video with an object without modifying the content of the video, the method comprising:
receiving a user selection of a frame within the video;
receiving user input indicative of spatial placement of the object within the frame;
receiving user input indicative of temporal placement of the object within the frame; and
storing object information in a data store, wherein the object information is stored in association with the video and includes the object or an identifier of the object, temporal information indicative of the frame within the video, and spatial information indicative of the spatial location of the object within the frame based on the placement of the object within the frame.

2. The method of claim 1, wherein the object comprises at least one of a text-based object, a user commentary, an image, an audio file, a video file, and a multimedia file.

3. The method of claim 1, wherein receiving a user selection of a frame within the video comprises:
presenting the video to a user; and
receiving a user command to allow insertion of a marker into the frame of the video.

4. The method of claim 1, wherein receiving user input indicative of the spatial placement of the object within the frame comprises:
receiving a command to provide a text box at a location within the frame;
presenting the text box at the location within the frame; and
receiving user input indicative of text entered into the text box.

5. The method of claim 1, wherein receiving user input indicative of the spatial placement of the object within the frame comprises:
receiving a user selection of a non-text object; and
receiving user input indicative of a location within the frame to place the non-text object.

6. The method of claim 5, wherein the non-text object is stored locally.

7. The method of claim 1, wherein the object information further comprises information indicative of at least one of a user marking the video with the object, an advertisement associated with the object, and a hyperlink associated with the object.

8. The method of claim 1, further comprising receiving further user input indicative of editing the object; and modifying the object information in the data store based on the further user input.

9. The method of claim 1, wherein the method further comprises:
receiving a command to present the video;
based on the command, accessing the video and the object information in the data store; and
presenting the video, wherein the object is presented in the video based at least in part on the temporal information and spatial information stored in the data store.

10. A method for indexing an object marking a frame within a video, the method comprising:
determining a tag associated with the object;
accessing a data store for indexing one or more objects used to mark one or more videos;
storing, in the data store, information indicative of the tag associated with the object, the video, and the frame within the video marked with the object.

11. The method of claim 10, wherein the object comprises at least one of a text-based object, a user commentary, an image, an audio file, and a video file.

12. The method of claim 10, wherein determining the tag associated with the object comprises automatically determining at least one of a keyword and an identifier associated with the object.

13. The method of claim 10, wherein determining the tag associated with the object comprises receiving user input indicative of a keyword to be associated with the object.

14. The method of claim 10, wherein accessing the data store for indexing one or more objects used to mark one or more videos comprises accessing a tag entry in the data store, the tag entry corresponding with the tag associated with the object

15. The method of claim 14, wherein accessing a tag entry in the data store comprises at least one of accessing an existing tag entry in the data store and creating a new tag entry in the data store.

16. A method for searching one or more videos using an index storing information associated with one or more objects marking the one or more videos, the method comprising:
receiving search input;
searching the index based on the search input;
determining one or more frames within the one or more videos based on the search input, the one or more frames containing one or more objects corresponding with the search input; and
presenting the one or more frames.

17. The method of claim 16, wherein receiving search input comprises receiving one or more tags, each of the one or more tags comprising at least one of a keyword and an object indicator.

18. The method of claim 17, wherein determining one or more frames within the one or more videos based on the search input comprises accessing one or more index entries corresponding the one or more tags, the one or more entries including information identifying the one or more frames within the one or more videos corresponding with the one or more tags.

19. The method of claim 16, wherein presenting the one or more frames comprises presenting one or more thumbnail images corresponding with the one or more frames.

20. The method of claim 19, wherein the method further comprises:
receiving a user selection of one of the one or more thumbnail images;
accessing the video corresponding with the selected thumbnail image; and
presenting the video, wherein the video is presented at a frame corresponding with the selected thumbnail image.
